(19) United States
(12) Patent Application Publication
(10) Pub. No.: US 2026/0129616 A1
(43) Pub. Date: May 7, 2026

(54) METHOD AND APPARATUS FOR ADAPTIVE WTRU REACHABILITY IN A WIRELESS NETWORK

(71) Applicant: InterDigital Patent Holdings, Inc., Wilmington, DE (US)

(72) Inventors: Michel ROY, Candiac (CA); Michael STARSINIC, Newtown, PA (US); Ulises OLVERA-HERNANDEZ, Saint-Lazare (CA); Saad AHMAD, Montreal (CA)

(73) Assignee: InterDigital Patent Holdings, Inc., Wilmington, DE (US)

(21) Appl. No.: 18/940,448

(22) Filed: Nov. 7, 2024

(51) Int. Cl. H04W 68/02; H04W 76/19; H04W 76/20

(52) U.S. Cl. CPC H04W 68/02; H04W 76/19; H04W 76/20

(57) ABSTRACT

Methods and apparatus for adaptative WTRU reachability in a wireless network are described. A wireless transmit/receive unit (WTRU) includes a processor and a transceiver, which are configured to connected to a wireless network and send a first message, via the wireless network. The first message includes information indicating that the WTRU will not monitor a paging channel of the wireless network when the WTRU is in an idle state. The processor and the transceiver also receive a second message, via the wireless network. The second message includes information indicating a reachability strategy for the WTRU, which includes paging the WTRU via an alternate source when the WTRU is in the idle state.

### BACKGROUND

In wireless networks, such as Long Term Evolution (LTE) or 5G wireless networks, there are times when a wireless transmit/receive unit (WTRU) connected to the network is not actively engaged in a data session or call (also referred to herein as an active state). A WTRU may take advantage of the fact that it is not actively being used and may temporarily discontinue running certain processes to save power. Accordingly, a WTRU may enter a low power, standby mode of operation, commonly referred to as an idle state, in which the WTRU is still connected to the wireless network but may not be reachable solely using mechanisms that the wireless network would use when the WTRU is in the active state.

When a WTRU is in an idle state, and there is an incoming call for the WTRU or downlink data that the network needs to send to the WTRU, the network may therefore need to use a different mechanism to reach the WTRU than it would when the WTRU is in the active state, to indicate, to the WTRU, an incoming call, short message system (SMS) message, or data notification, for example, that the WTRU needs to establish a signaling connection and user plane resources to receive. The process a wireless network typically uses to attempt to reach the WTRU when the WTRU is in the idle state is commonly referred to as paging.

### SUMMARY

Methods and apparatus for adaptative WTRU reachability in a wireless network are described. A wireless transmit/receive unit (WTRU) includes a processor and a transceiver, which are configured to connect to a wireless network and send a first message, via the wireless network. The first message includes information indicating that the WTRU will not monitor a paging channel of the wireless network when the WTRU is in an idle state. The processor and the transceiver also receive a second message, via the wireless network. The second message includes information indicating a reachability strategy for the WTRU, which includes paging the WTRU via an alternate source when the WTRU is in the idle state.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram of a wireless network including a core network architecture with a tracking and reachability function (TRF);

FIG. 3 is a signal diagram showing example reachability provisioning procedures between a WTRU and a TRF;

FIG. 4 is a signal diagram showing example reachability procedures between a WTRU and a TRF via an AF;

FIG. 5 is a signal diagram showing example reachability procedures between a WTRU and a TRF via alternative reachability sources;

FIG. 6 is a flow diagram of an example method of provisioning WTRU reachability, which may be implemented in a WTRU;

FIG. 7 is a flow diagram of an example method of paging a WTRU in an idle state when a reachability strategy has been provisioned for the WTRU, which may be implemented in a WTRU; and

FIG. 8 is a flow diagram of an example method of provisioning WTRU reachability, which may be implemented at the tracking and reachability function in the core network, as shown in FIG. 2.

### DETAILED DESCRIPTION

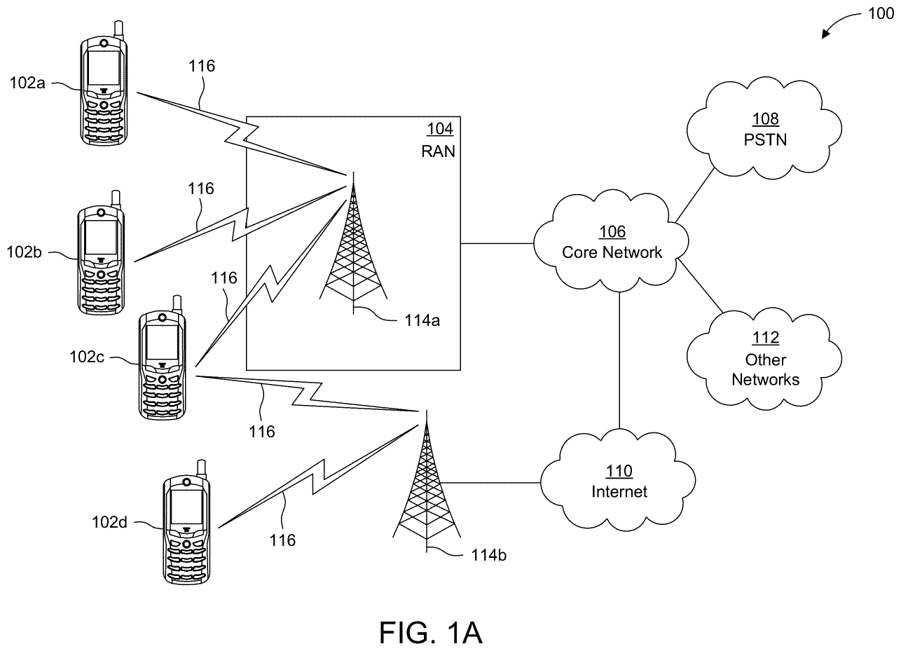

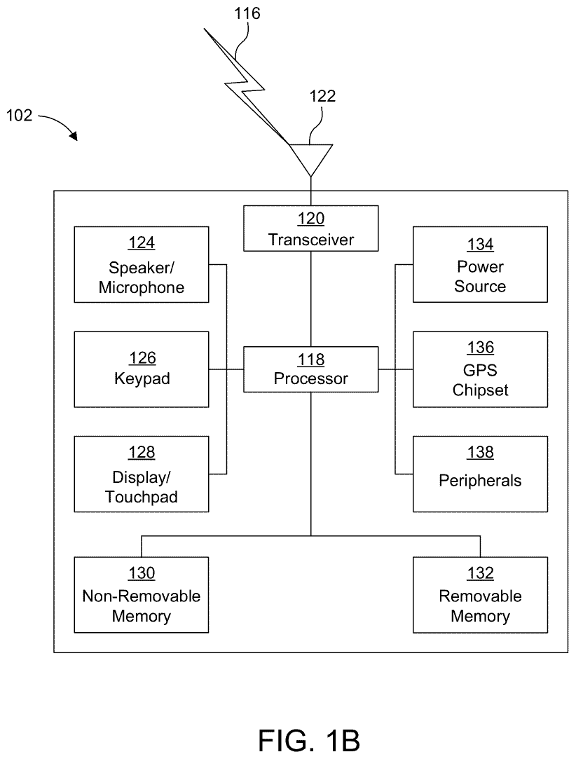

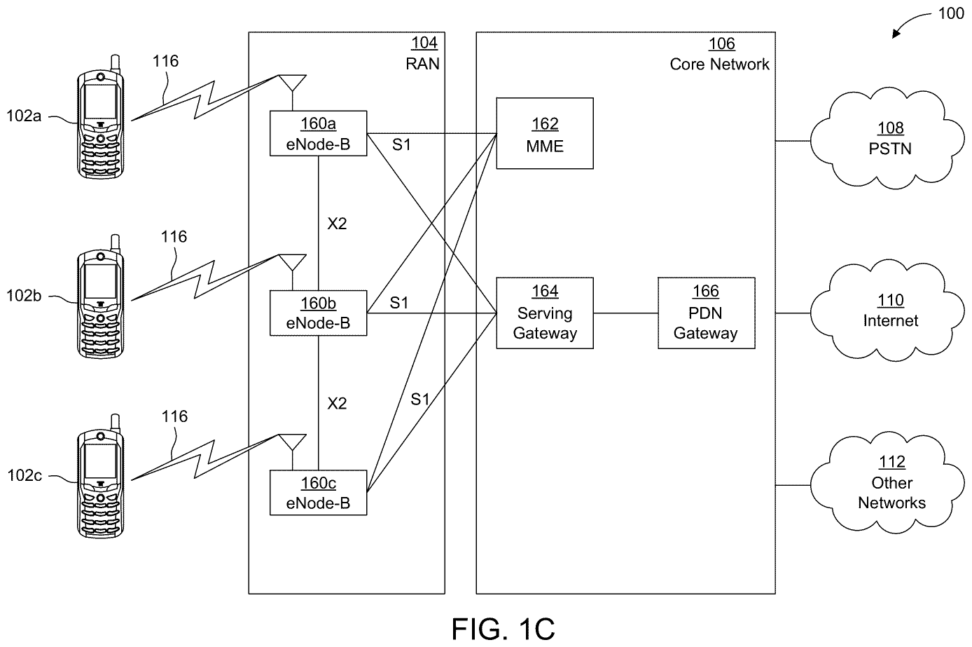

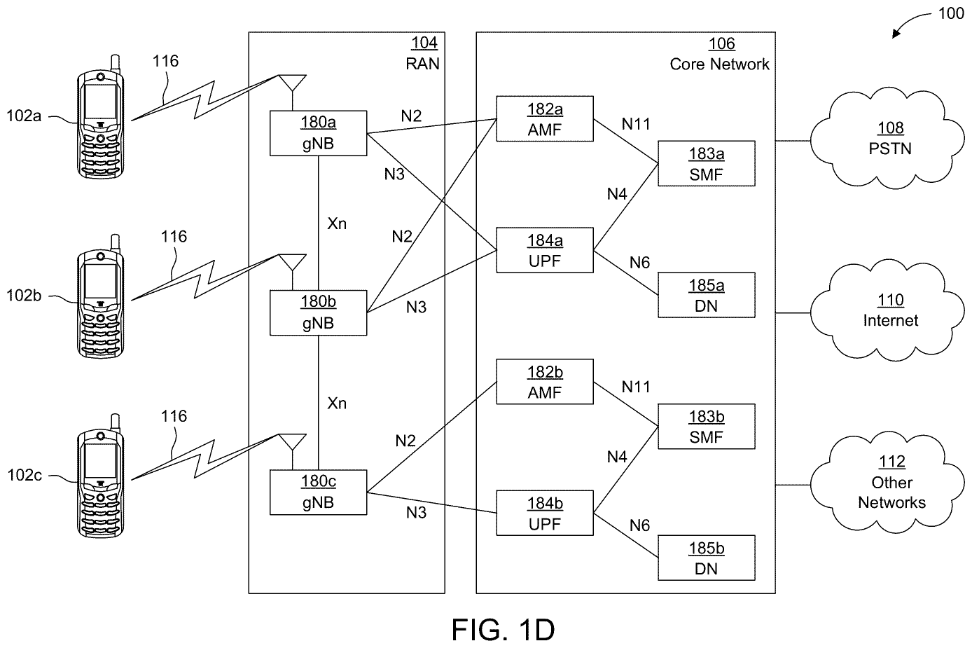

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In a 5G system (5GS), when a WTRU is in an idle state, and the network needs to reach the WTRU, a core network component, or network function (NF), may initiate paging of the WTRU. To do so, the core network component or NF may generate a paging notification or message, which may include information indicating, for example, an identifier (e.g., temporary mobile subscriber identity (TMSI) or international mobile subscriber identity (IMSI)) of the WTRU to be paged and information indicating an event type (e.g., incoming call, SMS, data, etc.). The core network component or NF may send the paging notification to an Access Network (AN), which broadcasts it. In addition to the WTRU identifier and event type, the core network component or NF may include, in the paging notification it generates, information indicating parameters that the AN may need or otherwise use to execute its paging strategy, such as a 5G QoS identifier (5QI) and/or an allocation and retention priority (ARP). By way of example, core network components or NFs that may initiate paging and generate paging notifications may include, depending on the nature of the data to be transferred to the WTRU, an access and mobility function (AMF), a session management function (SMF), a policy control function (PCF), a unified data management (UDM) entity, or a location management function (LMF). In a 5GS, ANs are typically associated with gNBs, and the core network component or NF may determine the specific NF to send the generated paging notification to for broadcasting based on the WTRU's last known location or tracking area (TA).

A WTRU in idle mode may listen to the designated paging channel of the gNB where the WTRU is camped. When the WTRU detects a paging notification on the paging channel, the WTRU may determine if the paging message is intended for the WTRU. If the WTRU determines that the paging message is intended for the WTRU, the WTRU may respond, for example by sending an NAS service request message that may indicate the WTRU's readiness to establish communication. An AMF in the CN may receive the NAS service request message, which may trigger procedures to establish a communication session with the WTRU for the data transfer.

A CN component or NF initiating paging of a WTRU in an idle state needs to determine which AN and/or gNB to contact for broadcasting of the paging notification. Ideally, the determination should happen in a balanced manner since paging resources in a network, and at the gNB, are limited. In this context, paging resources relates to paging channel capabilities of the 5G network. Since paging messages are broadcasted over the network and paging resources are limited, efficient management of paging traffic is needed to avoid network congestion.

In addition to paging resources, paging latency, paging power consumption, paging efficiency, and paging scalability may also have a high impact on network operation. Paging latency, relating to the time between paging initiation at the CN and establishment of communication with the WTRU, may have a high impact on network operation, for example, because the paging decisions or algorithm made by/run by the CN component or NF to determine which AN(s) and/or gNB(s) to use for broadcasting of the paging notification directly influences paging latency, which in turn influences how quickly the user is informed of incoming communications and user experience. In addition, paging power consumption, related to the battery power needed to analyze paging traffic received at the WTRU, may have a high impact on network operation. For example, a WTRU enters idle mode for the purpose of preserving power, but it still needs to listen to paging messages sent on the paging channel of the gNB it is camped on. The frequency of paging occasions, during which a page may be sent on a paging channel, may influence WTRU battery life due to the constant need to trigger processing mechanisms in the WTRU to analyze paging messages. Additionally, paging efficiency, relating to the odds of reaching a WTRU in the idle state, may have a high impact on network operation. For example, if a WTRU in idle mode is located in a poor coverage area, or if a WTRU moves out of a tracking area, where the initial paging attempt took place, thereby causing a subsequent attempt extending the paging area, the paging efficiency may decrease, resulting in higher latency to reach a WTRU and higher network paging resource consumption. Finally, paging scalability, relating to the capability of the network to handle a high volume of WTRUs and paging messages, may have a high impact on network operation. For example, when congestion occurs on the paging channel, it may become impossible at worst, or inefficient at best, to page a WTRU, which may result in missed calls, data session timeout, and/or poor user experience.

Several examples of unbalanced paging approaches are illustrative. In a first example of an unbalanced paging approach, the CN or NF may broadcast a paging notification to all gNBs in the network. While this approach would provide high odds of reaching the idle state WTRU with minimal delay, it would also waste tremendous network paging resources. In a second example of an unbalanced paging approach, the CN or NF may send a paging notification to one gNB at a time. While this approach would preserve network resources as compared to the first example approach, it would provide low odds of reaching the WTRU with potentially long delays.

At least because the paging process for WTRUs connected to a network in an idle state is an essential process involving consumption of limited network resources (e.g., the paging channel) and impacts the WTRU and user in various ways (e.g., battery life, latency, user experience), the WTRU paging process should be configured in such a way that provides a balance between network constraints and user experience and should be constantly maintained. To achieve a good balance between network constraints and user experience, the WTRU paging process typically relies on WTRU location tracking information, and the network may be capable of achieving a good balance between network constraints and user experience if the WTRU location tracking information available in the network is accurate and precise. A description of conventional WTRU location and tracking capabilities of the 5GS follows.

In the 5GS, the AMF typically manages WTRU mobility and tracking via WTRU registration, WTRU session management, and WTRU location updates. 5G networks are typically divided in multiple tracking areas (TAs), each of which may include a set of cells. Each of the cells is associated with a gNB, and each cell or gNB is typically configured to broadcast a single TA. The location of a WTRU is typically tracked based on the TA in which the WTRU is currently located. When a WTRU moves from one TA to another, a WTRU location update is triggered, and, as a result, the WTRU informs the AMF in the core network of the new WTRU TA location, for example by sending a registration request to the network informing the AMF of the WTRU's current location. Additionally, or alternatively, a 5G WTRU may periodically send a registration request to the network to inform the AMF of the WTRU's current location. This information may be used by the network when paging a WTRU for incoming calls or data when the WTRU is connected to the network in an idle state.

Since wireless device users are not typically actively using their phones, or other wireless devices, at all times, WTRUs are frequently connected to a wireless network in the idle state and need to be alerted by paging notifications about incoming network communications. Accordingly, WTRU tracking procedures, such as described above, may be considered to be essential for the operation of the wireless network. Such procedures may provide information to the network about a current location of the WTRU. While paging and tracking procedures may operate independently of paging procedures, the integrity of the tracking information itself is crucial as it may influence and enhance a network's paging performance.

Accordingly, as mentioned above, a balanced approach to WTRU paging is highly desirable to preserve the limited paging resources of the wireless network while ensuring good user experience related to, for example, latency and/or WTRU battery life. However, WTRU paging and tracking capabilities in the 5G CN may be limited, such as by network design characteristics, such as TA allocations, by a WTRU's reporting capabilities, such as TA reporting, and/or by WTRU paging algorithms that are determined based on TA allocations and TA reporting. As such, it may be difficult to design WTRU paging algorithms that provide a balanced approach for all possible network topologies and in all possible network conditions.

Additionally, WTRU paging capabilities in the 5G CN are provided by the AMF, which is a complex functional entity typically responsible for multiple operational aspects of the wireless network. Due to its complexity, it may be prohibitively difficult to evolve the AMF itself to improve WTRU paging. Evolution of the 5G network has included discussions about decentralizing some of the functionality of some network functions and, due to the complexity of the AMF, there may be a significant desire to decentralize the functionality of the AMF into more specialized functions. Accordingly, WTRU paging and tracking may be considered as a strong candidate for decentralized, specialized functions.

Functions and information flows are described hereinbelow for providing advanced and adaptive WTRU paging for next generation mobile systems. A network architecture and associated procedures are defined herein that support decentralizing the AMF functionality to provide an evolved, standalone, paging function and improve WTRU paging performance. Such enhancements to the network architecture, and associated procedures, may also provide opportunities to address WTRU paging challenges by providing new capabilities. The network may, therefore, provide a new tracking and reachability service via a tracking and reachability function (TRF). The TRF may allow a WTRU to be paged via alternate sources that were not previously supported.

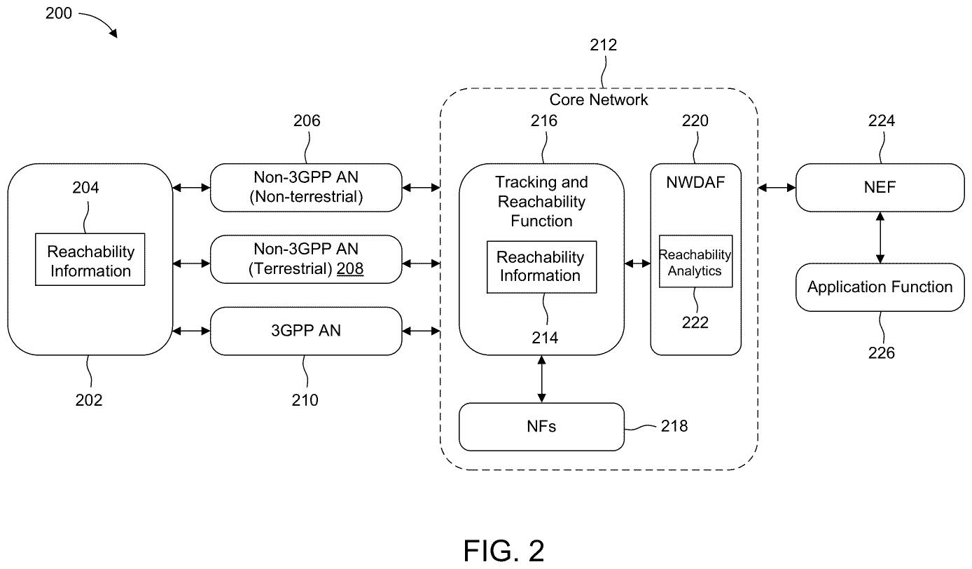

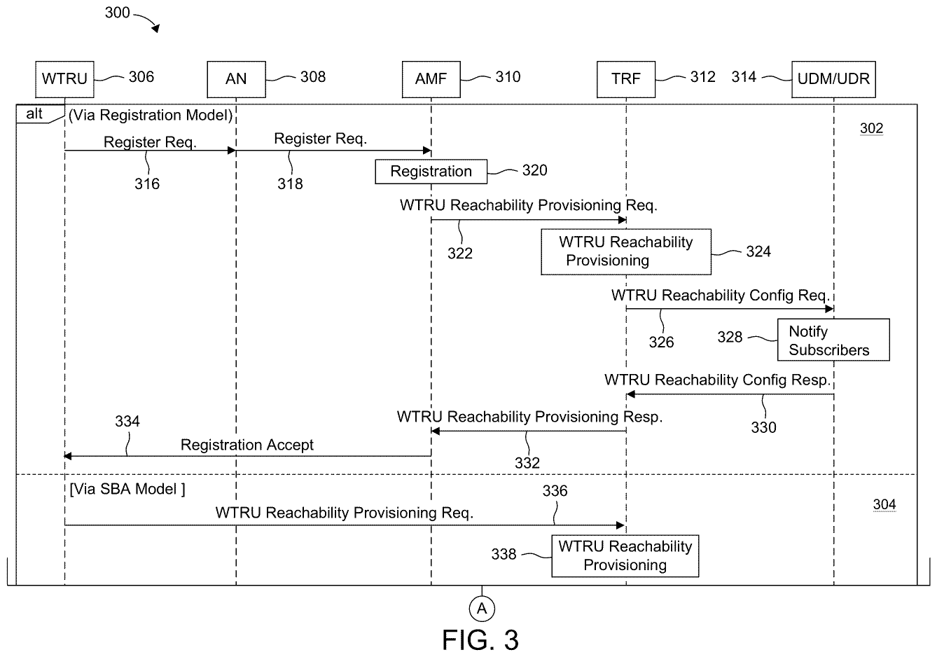

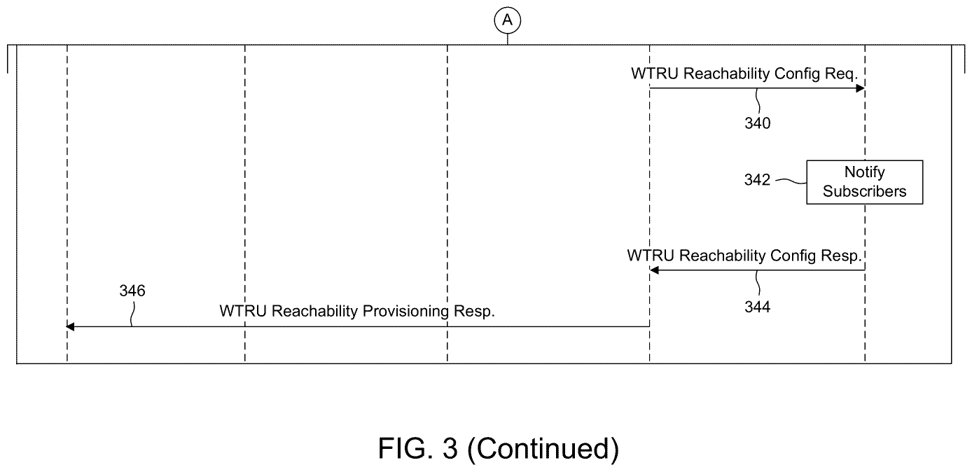

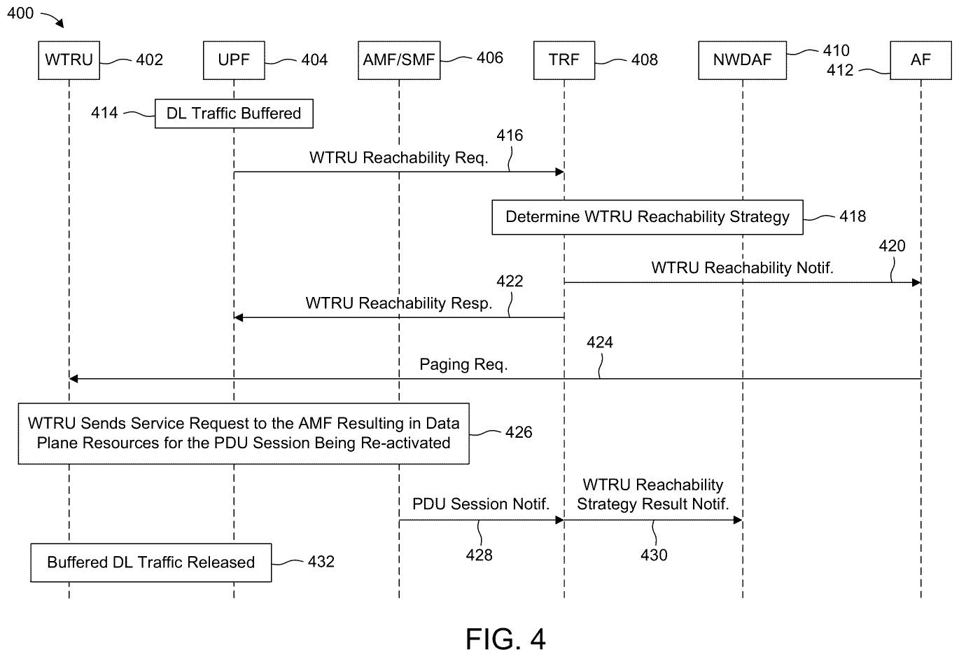

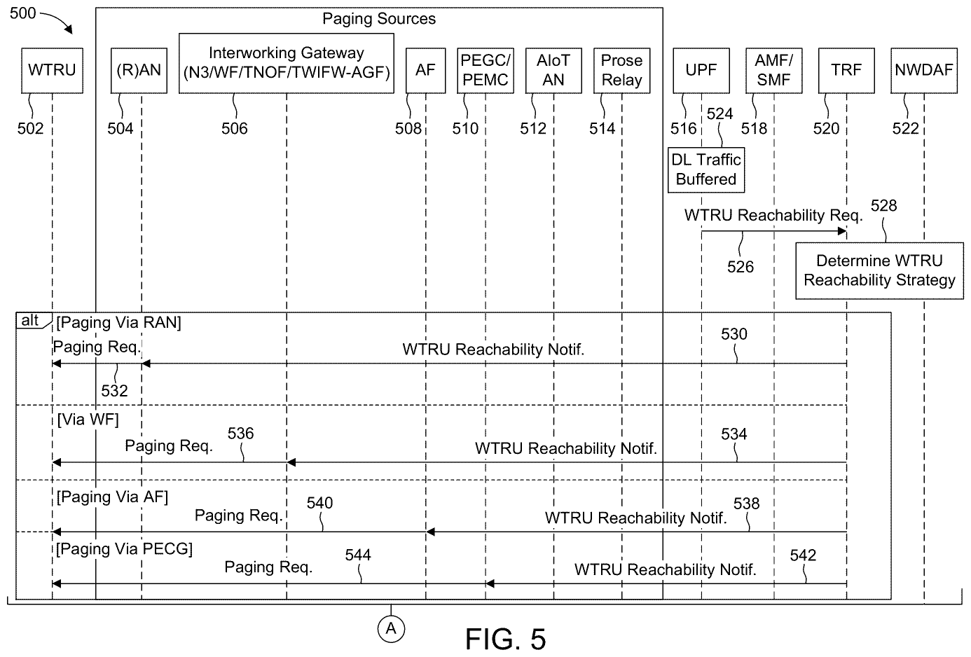

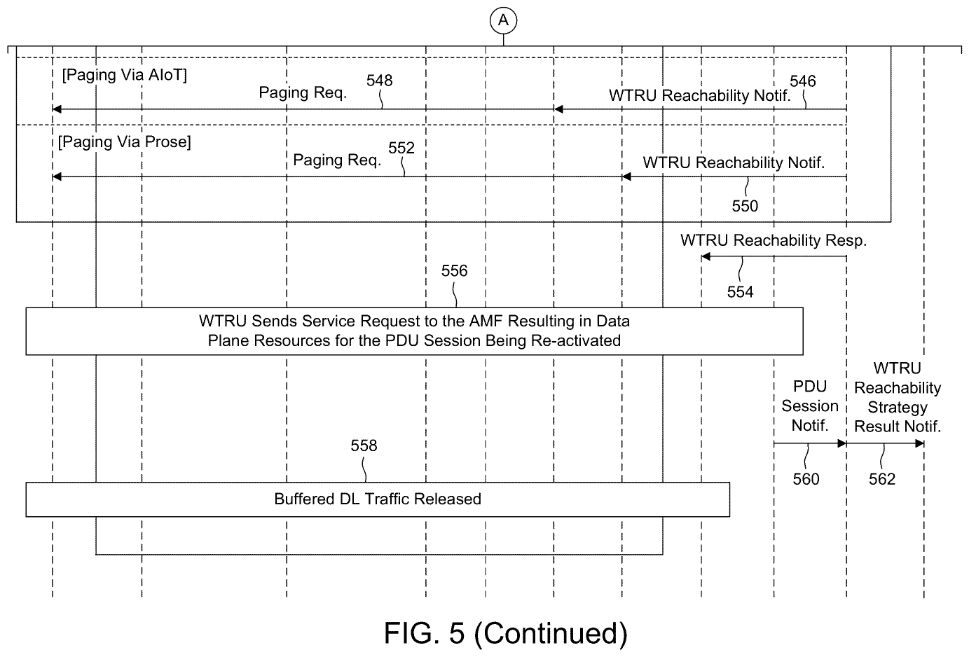

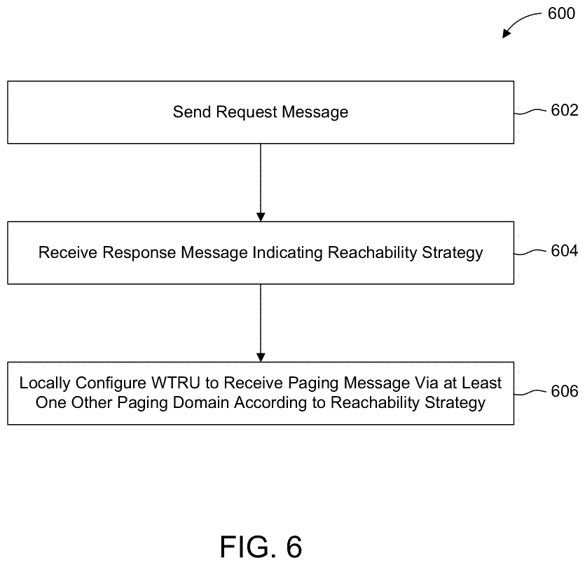

A high-level overview of architecture enhancements, including the TRF, are described with reference to FIG. 2. The TRF architecture decouples the tracking functions from the AMF, simplifying the AMF operation. The architecture illustrated and described with respect to FIG. 2 enables a WTRU to provision reachability information, enabling new paging capabilities within the network, which are illustrated in, and described with respect to, FIG. 3. The architecture and associated paging procedures may provide capabilities for paging a WTRU via different paging domains, which may improve the reachability performance of the network. Procedures associated with paging a WTRU via different paging domains are illustrated in, and described with respect to, FIGS. 4 and 5 and may improve the reachability performance of the network. Flow diagrams of some of the procedures described, for example, with respect to FIGS. 3, 4 and 5 are illustrated in, and described with respect to, FIGS. 6, 7 and 8. The architecture and procedures illustrated in, and described with respect to, FIGS. 2-8, may facilitate AI assisted WTRU paging in the network. In other words, the network may use available information and knowledge about a certain WTRU to determine how to page the WTRU (e.g., methods used and paging frequency). This may improve the network's paging predictions by integrating new paging domains for training paging AI/ML models, thereby providing a system architecture and associated procedures that may improve the integrity of WTRU tracking and reachability information, which can considerably improve network operation.

The terms paging domain and reachability domain are used interchangeably herein to refer to the technology and methods used to page a WTRU. Sometimes, a paging or reachability domain may refer to a particular network used for paging when the WTRU enters an idle state. For example, according to embodiments described herein, a WiFi paging or reachability domain may be used to page a WTRU that is connected to a gNB of a 5G RAN in idle mode. In other instances, a paging or reachability domain may refer to paging a WTRU via a particular, such as by using traditional paging or reaching a WTRU using an ambient IoT (aIoT) device, for example. The term alternate source may be used more broadly herein to refer to any mechanism, method, device, channel or network used for paging or otherwise reaching a WTRU that is connected to a wireless RAN in idle mode via a mechanism, method, device, channel, or network other than traditional (or legacy) RAN paging methods or mechanisms, as would be understood by one of ordinary skill in the art. Or in other words, an alternate source may be considered to be a functional entity that generates a paging message towards a WTRU using a network or communication technology different from the paging technology of the RAN. One or ordinary skill in the art will recognize, as well, that a WTRU that is capable of being reached by one or more alternate sources may also still be reached using traditional RAN paging (commonly referred to as legacy paging in this context) and, therefore, legacy paging may still be considered when determining a reachability strategy for the WTRU and may be included as part of a WTRU's determined reachability strategy.

Several different paging/reachability domains or alternate sources are given herein as specific examples. These are, namely, a RAN paging domain, a WiFi paging domain, an aIoT paging domain, an interworking gateway paging domain, and an AF paging domain. One or ordinary skill in the art will understand that other paging/reachability domains and/or alternate sources, not specifically listed herein, may be used for paging or otherwise reaching a WTRU in an idle state, without departing from the scope of the invention.

The RAN paging domain refers to using RAN mechanisms for paging a WTRU. Using a RAN paging domain, the RAN may send the WTRU a signal via the mobile network over the RAN paging channel to trigger the WTRU to perform a service request procedure with a cellular network. The information indicated by this signal is commonly referred to as a paging notification, a paging message, a paging indication, or simply a page, and it triggers a device that it is intended for to initiate acquisition of any information that is being buffered for the WTRU by an entity in the RAN network.

The WiFi paging domain refers to using a WiFi network mechanism for paging a WTRU. Using the WiFi paging domain, an application layer message may be sent to the WTRU via a WiFi network to trigger the WTRU to perform a service request procedure with the cellular network.

The aIoT paging domain refers to using aIoT mechanisms for paging a WTRU. Using the AIoT paging domain, a signal may be sent to a WTRU via an aIoT reader to trigger the WTRU to perform a service request procedure with the RAN.

The interworking gateway paging domain (e.g., N3IWF/TNGF/TWIF/W-AGF) refers to using an interworking gateway mechanism for paging a WTRU. Using an interworking gateway paging domain, a NAS message may be sent to the WTRU via the interworked network to trigger the WTRU to perform a service request procedure with the RAN.

The AF paging domain refers to using an AF mechanism for paging a WTRU. In an AF paging domain, an application layer message may be sent to the WTRU via an independent network (other than the RAN) to trigger the WTRU to perform a service request procedure in a cellular network.

By way of example, a WTRU may include an application client, which may send a reachability provisioning request to a tracking and reachability function (TRF) of a cellular network. The request may include an indication that the WTRU will not listen to the paging channel of the cellular network when the WTRU's connection to the cellular network is in an idle state. The reachability provisioning request may include reachability information, as described in more detail below. The WTRU may further receive a reachability provisioning response from the TRF of the cellular network that may include information that the WTRU may use to apply a local configuration for alternative paging domains.

After the WTRU's connection with the network enters the idle state, the WTRU may receive a message, from an AF, via a second network. This message from the AF may include information about downlink data that the cellular network has to send to the WTRU and may trigger the WTRU to send a service request message to the cellular network. The service request message may indicate at least one PDU session that should be activated, and the WTRU may determine which PDU Session to activate based on the information about downlink data that the cellular network has to send to the WTRU. The service request message triggers the WTRU's connection with the network to transition from the idle state to a connected state, and the WTRU receives downlink data from the cellular network via the activated PDU Session.

FIG. 2 is a system diagram of a wireless network 200. The wireless network 200 illustrated in FIG. 2 includes a core network (CN) 212 and a WTRU 202 connected to the CN 212. In the example illustrated in FIG. 2, the CN 212 includes a tracking and reachability function (TRF) 216, a functional entity within the CN 212. The TRF 216 may be part of a Service Based Architecture (SBA) and may provide functionality for paging the WTRU 202 through an interface or an API. More specifically, the TRF 216 may implement functionality for reaching the WTRU 202 to inform the WTRU 202 about incoming communications, such as an incoming call or downlink data for the WTRU 202 The TRF 216 may send messages to, or receive messages from, the WTRU 202, one or more Network Functions (NFs) 218 within the CN 212 of the wireless network 200, an Application Function (AF) 226 outside the CN 212, and/or one or more Access Network (AN) 206, 208 and/or 210 that interact with the CN 212 of a wireless network 200.

The WTRU 202 may consume services from the TRF 216 in the CN 212, such as to obtain or provide WTRU reachability information. Such reachability information, may be stored, for example, as reachability information 204 in at last one memory in the WTRU 202. Reachability information provided to the TRF 216 may likewise be stored locally to the TRF 216, as indicated by reachability information 214. WTRU interactions with the TRF 216 may occur using the Non-Access Stratum (NAS) protocol. The NAS payload may be transported over service-based interfaces (SBIs) or over dedicated point to point interfaces, such as N2, dependent on WTRU and network capabilities.

The reachability information may include, for example, information about the identity of the WTRU 202 and/or information about WTRU connectivity and/or reachability that may be exchanged between the WTRU 202 and the TRF 216, stored in the TRF 216, and/or a UDM entity (not shown), and/or a unified data repository (UDR) (not shown) and used to determine a reachability strategy for the WTRU 202 (described in more detail below) and reach the WTRU 202 in an idle state. More specifically, reachability information may include any one or more of: reachability capabilities (RCap) information, WTRU connectivity information (UECI), WTRU identity (UEID) information that may identify the WTRU 202, reachability information (RInfo) and/or reachability configuration (RConf) information.

RCap (or an RCap information element (IE)) may provide information about capabilities of a WTRU 202 for being reached by the network and/or capabilities of the TRF 216 for reaching the WTRU 202. RCap information may be pre-configured, obtained, or otherwise available at the WTRU 202 and/or the TRF 216 and may be exchanged between the WTRU 202 and the TRF 216. RCap may be used by the TRF 216 to determine reachability strategies for the WTRU 202. RCap may indicate reachability methods supported by a WTRU 202 for being paged by the TRF 216 or by the TRF 216 for paging the WTRU 202. For example, RCap may indicate that paging is supported via different paging domains, such as the wireless network itself, a WIFI network, ambient IoT mechanisms, an interworking gateway (e.g., a non-3GPP Interworking Function (N3IW), a trusted non-3GPP gateway function (TNGF), a trusted WLAN Interworking Function (TWIF), and/or a wireline access gateway function (W-AGF)) or via an AF associated with an application on the WTRU 202. In some embodiments, RCap may provide information about the capabilities of a WTRU 202 for reaching other WTRUs. For example, RCap may indicate that the WTRU 202 is capable of acting as a mobile hotspot to send paging indications to connected WTRUs. For another example, RCap may indicate that the WTRU 202 is capable of acting as a proximity services (Prose) relay and can act a Prose relay to send paging indications to WTRUs.

UECI (or a UECI IE) may provide information about connectivity supported for reaching the WTRU 202. UECI may be pre-configured, obtained, or otherwise available at the WTRU 202 and may be provided to the TRF 216. The TRF 216 may use the UECI when determining a reachability strategy for the WTRU 202. UECI may include the IP address of the WTRU 202, WTRU interworking gateway information (e.g., identifier and address of the gateway), AF information (e.g., URL, URI, IP address, AF identifier) of an AF associated with the WTRU 202, personal IoT network (PIN) information (e.g., PIN identifier, PIN server endpoint, PEGC IP address, and/or PEMC IP addresses) of a PIN that the WTRU is member of, ambient IoT (aIoT) information (e.g., aIoT device identifier and triggering information) for triggering an aIoT device associated with the WTRU 202, and/or Prose relay information (e.g., IP address) of a Prose relay used by the WTRU 202.

RInfo (or an RInfo IE) may provide information about reachability of the WTRU 202. RInfo may be determined by the TRF 216, for example based on RCap and WTRU tracking information and may be provided to the WTRU 202 or reachability information subscribers. For example, assuming that RCap indicates WTRU capability for being reached via different domains (e.g., via the wireless network 202, via an AF, and via a PIN), and further assuming that WTRU tracking information indicates that the WTRU 212 has not currently joined the PIN, then RInfo determined by the TRF 216 may indicate that the WTRU 202 should first be reached via the AF, then via the wireless network. Further, assuming that WTRU tracking information indicates that the WTRU 202 has currently joined the PIN, the RInfo determined by the TRF 212 may indicate that the WTRU 202 should first be reached via the PIN, then via the AF, then via the wireless network 200.

RConf (or an RConf IE) may provide configuration information related to reachability of the WTRU 202. RConf may be available (e.g., pre-configured or obtained) at the WTRU 202 and/or the TRF 216. The WTRU 202 may provide RConf to the TRF 216 as a desired reachability configuration, for example, and/or to provide configuration information about alternate reachability methods. RConf may be considered by the TRF 216 when determining a paging method. For example, RConf may indicate to the TRF 216 that the WTRU 202 desires to be paged via a specific paging domain during a certain period, and/or or at a certain location, and/or on certain IP ports. For example, RConf may include the URL, URI, IP address, and/or AF identifier of an AF, such as the AF 226, to be used for paging the WTRU 202.

The TRF 216 may provide RConf to the WTRU 202, and the RConf may indicate a determined reachability configuration and/or indicate configuration information for alternate reachability methods. RConf may be used by the WTRU 202 to perform local configuration(s) related to the alternate reachability methods. For example, RConf may indicate to the WTRU 202 the IP port number where paging messages will be sent, and the WTRU 202 may, accordingly, listen on that port. For another example, RConf may include the URL, URI, and/or IP address of an AF that should be used by the WTRU 202 for receiving paging requests, and the WTRU 202 may establish a connection to the AF 226 using the RConf.

Returning to FIG. 2, the CN 212 includes a network data and analytics function (NWDAF) 220. The NWDAF 220 collects, analyzes and utilizes data from various sources to enhance performance and management of the wireless network 200. The NWDAF 220 may be enhanced with Reachability analytics 222 and may interact with the TRF 216 to provide predictions specific to WTRU paging, as described in more detail below.

The wireless network 200 illustrated in FIG. 2 also includes one or more network functions (NFs) 218, which are provided by the CN 212, and one or more application functions (AFs) 226, which may be located outside of the CN 212 and may consume services provided by the TRF 216 of the CN 212, such as to obtain or to provide WTRU paging information. The one or more NFs 218 and the one or more AFs 226 may communicate with the TRF 216 either directly or indirectly. For example, an NF 218 within the CN 212 may communicate directly with the TRF 216 while the AF 226, which is an untrusted AF in this example, may only communicate indirectly with the TRF 216 via a network exposure function (NEF) 224.

The wireless network 200 illustrated in FIG. 2 also includes ANs 206, 208 and 210 on a communication path between the WTRU 202 and the CN 212, which may enable the CN 212 to communicate with the RAN. Multiple ANs 206, 208 and 210 may be available to the core network 212, and each of the ANs 206, 208 and 210 may be for different access technologies. For example, the AN 206 is a non-3GPP AN that enables the CN 212 to interact with non-terrestrial or satellite networks, the AN 208 is a non-3GPP AN that enables the CN 212 to interact with terrestrial networks (e.g., WiFi), and the AN 210 is a 3GPP AN that enables the CN 212 to interact with a 3GPP or cellular network. Non-3GPP networks may require a non-3GPP gateway function (not shown) within the core network to interface with the core network. For example, the Non-3GPP Interworking Function (N3IWF) may be deployed as a network function and may be responsible for interworking between an untrusted non-3GPP network and the core network. Other examples of interworking gateways include Trusted Non-3GPP Gateway Function (TNGF), Trusted WLAN Interworking Function (TWIF) and Wireline Access Gateway Function (W-AGF).

FIG. 3 is a signal diagram 300 showing example reachability provisioning procedures between a WTRU 306 and a TRF 312. The example illustrated in FIG. 3 provides two example reachability provisioning procedures 302 and 304. The reachability provisioning procedure 302 is an example of a reachability provisioning procedure via network registration. The reachability provisioning procedure 304 is an example of a reachability provisioning procedure using a service based architecture (SBA). As compared to the reachability provisioning procedure 302 via network registration, in the reachability provisioning procedure 304, the TRF function 312 may be deployed as a network service accessible via an SBA. The WTRU 306 may discover the TRF 312. For example, TRF service communication information (e.g., URL, URI, endpoint) may be provided to the WTRU 306 via network registration, or via an explicit discovery request sent to the network.

In the example reachability provisioning procedure 302, the WTRU 306 registers to a wireless network. In the example illustrated in FIG. 3, the WTRU 306 sends a registration request 316 to the AN 308. The AN 308 may select an AMF and forward the registration request (318) to the selected AMF 310. The registration request 316/318 may additionally include reachability information, which may include any one or more of the RCap information, UECI, UEID and/or RConf information described herein.

The AMF 310 may perform WTRU registration (320). WTRU registration (320) may include selection of various NFs, such as an authentication server function (AUSF), a UDM and/or a PCF, authorization of the WTRU 306 to use the network, and transferring WTRU context information. Additionally, as part of WTRU wireless network registration (320), an AMF 310 may select a TRF 312 for handling the reachability of the WTRU 306. Selection of the TRF 312 may be based on one or more of subscriber profile information, the selected AMF, or the reachability information. For example, the TRF 312 may be selected based on matching RCap values of the TRF 312 with RCap values indicated by the WTRU 306.

The AMF 310 may send a WTRU reachability provisioning request message 322 to the selected TRF 312. The WTRU reachability provisioning request message 322 may include, for example, information about the associated AMF 310 and the received reachability information. The TRF 312 receiving the WTRU reachability provisioning request message 322 may locally store reachability information included in the request message 322 and associate the reachability information with an identity/identifier of the WTRU 306. Additionally, the TRF 312 may perform any of the following actions. The TRF 312 may assign a reachability identifier (RID) to the WTRU 306. The TRF may determine common reachability capabilities supported by the WTRU 306 and the TRF 312 based on RCap value(s) at the TRF 312 and RCap value(s) provided by the WTRU 306. The TRF 312 may determine a reachability strategy for the WTRU 306, which may be indicated as RInfo. The RInfo determination may be based on matching the RCap values included in the registration request 316/318 and RCap values configured in the TRF 312. The TRF 312 may also consider subscriber information, the local configuration of the TRF 312, and the WTRU tracking information (e.g., location, TA, etc.) to determine the values for RInfo.

The TRF 312 may determine that data analytics services may assist the TRF 312 in determining WTRU paging strategies. The determination may be based on the determined common RCap values supported by the WTRU 306 and the TRF 312 and based on capabilities provided by a data analytics service. For example, the TRF 312 may obtain services from an NWDAF (not shown), an Application Data Analytics Enablement Service (ADAES) (not shown), and/or an AI/ML Enablement (AIMLE) layer (not shown) to obtain analytics and/or infer paging prediction (e.g., determine a paging strategy). For another example, the TRF 312 may request and/or subscribe to tracking and/or paging analytics (e.g., with the NWDAF or ADAES). The analytics obtained from the analytics service can be used by the TRF 312 to determine a WTRU reachability strategy based on tracking or paging analytics. In some embodiments, the TRF 312 may discover an AI/ML model (e.g., with an AI/MLE) for inferring paging prediction, or, in other words, the TRF 312 may predict a reachability strategy for the WTRU 306 that may provide a high confidence level of success. In some embodiments, the TRF 312 may enroll the WTRU 306 in an AI/ML federated learning process for purposes of training an AI/ML model based on WTRU reachability results (e.g., paging results based on the determined paging strategy and WTRU context). The enrollment may be temporary (e.g., until the AI/ML model is trained). The TRF 312 may use the paging results, determined reachability strategy, and WTRU context as training data for an assistance AI/ML model for WTRU paging prediction and may determine to use the trained model for determining a WTRU paging prediction (reachability strategy).

The TRF 312 may send a WTRU reachability configuration request message 326 to the UDM 314. The reachability configuration request message 326 may include reachability information, such as RID, RCap, determined RCap, UECI, UEID, received RConf, determined RConf, and/or RInfo. The UDM 314 may create or update an entry to store the reachability information associated with the WTRU 306 in the UDM 314. If the UDM 314 determines subscribers for reachability information associated with the WTRU 306, the UDM 314 may send a notification message (328) to the determined subscribers, and the notification message may include reachability information. The UDM 314 may also send a WTRU reachability configuration response message 330 to the TRF 312. The WTRU reachability configuration response message 330 may include an identifier for the created or updated entry and an indication of success or failure.

The TRF 312 may send a WTRU reachability provisioning response message 332 to the AMF 310. The WTRU reachability provisioning response message 332 may include RID and may include information for communicating with the TRF 312, such as a TRF identifier, a URL, a URI or endpoint information. The RID, the TRF identifier and the WTRU identifier may be used to perform management operations (e.g., read, update, delete) of the reachability information. The TRF 312 may include the reachability information, such as the determined RCap, determined RInfo, and determined RConf resulting from the reachability provisioning in 324.

The TRF 312 may send a registration accept message 334 to the WTRU 306. The registration accept message 334 may include information from the WTRU reachability provisioning response message 332. Upon receiving the WTRU reachability provisioning response message 332, the WTRU 306 may consider the reachability strategy (e.g., RInfo, RConf) determined by the TRF 312 to perform local configuration needed to receive paging requests according to the determined reachability strategy. Performing local configuration may include establishing connectivity with a server, device, and/or network and may additionally include listening on a port for incoming paging messages. For example, if the reachability strategy indicates that the WTRU 306 can be paged via an AF, the WTRU 306 may establish connectivity to such AF and perform local configuration to receive paging notifications on the port indicated by RConf. For another example, if the reachability strategy indicates that the WTRU 306 can be paged via a PIN (e.g., PEMC or PEGC), via an aIoT trigger, via a Prose relay, and via an interworking gateway, then the WTRU 306 may establish connectivity with the PIN, Prose relay or interworking gateway and perform local configuration to receive paging notifications from these sources.

For reachability provisioning via an SBA, the TRF 312 may be deployed as a network service accessible via an SBA. The WTRU 306 may discover a TRF 312. TRF service communication information (e.g., URL, URI, or endpoint) may be provided to the WTRU via network registration or via an explicit discovery request sent to the network.

The WTRU 306 may send a WTRU reachability provisioning request 336 to the TRF 312. The WTRU reachability provisioning request 336 may include reachability information, such as RCap, UECI, UEID, and RConf. Upon receiving WTRU reachability provisioning request 336, the TRF 312 may perform reachability provisioning, such as described above with respect to WTRU reachability provisioning 324. The TRF 312 may store WTRU reachability configuration information in the UDM 314 (340, 342, 344) similar to the manner described above with respect to 326, 328 and 330.

The TRF 312 may send a WTRU reachability provisioning response message 346 to the WTRU 306. The WTRU reachability response message 346 may include the same or similar information to that included in the WTRU reachability provisioning response message 332 in 302. The WTRU 306 may take action in response to receiving the WTRU reachability provisioning response message 346 similar to the actions taken by the WTRU 306 in response to receiving the registration accept message 334, as described above.

One of ordinary skill in the art will understand that reachability provisioning via network registration and via an SBA can be combined. For example, during network registration, the AMF 310 may select a TRF 312 for serving the registering WTRU 306 and may provide connectivity information for the selected TRF 312 to the WTRU 306. The WTRU 306 may then use the connectivity information for the TRF 312 to connect to the TRF 312 via SBA mechanisms.

FIG. 4 is a signal diagram 400 showing example reachability procedures between a WTRU 402 and a TRF 408 via an AF 412. It should be understood that the reachability procedures shown in, and described with respect to, FIG. 4, may occur after reachability provisioning, as shown in, and described with respect to, FIG. 3. For example, RCap, UECI, RInfo, and RConf may be used to determine a WTRU reachability strategy, which may include reachability via an AF, as in FIG. 4.

In the example illustrated in FIG. 4, a UPF 404 receives downlink traffic while the WTRU 402, for which the traffic is destined, is in idle mode. The UPF 404 may buffer (414) the incoming traffic until connectivity to the WTRU 402 is re-established. The determination that a WTRU is in idle mode may be based on a WTRU state maintained in the network. For example, WTRU state information may be maintained in, and/or stored at, the AMF, SMF, UPF, AN, at a state management function, or in the UDM/UDR.

The UPF 404 may send a WTRU reachability request message 416 to the TRF 408. The TRF 408 may be the TRF 408 that was selected by the AMF 406 during the reachability provisioning phase described above with respect to FIG. 3. The WTRU reachability request message 416 may include information about an identifier of the WTRU 402 to be paged, authorization information about the requested operation, information about a cause of the request, and/or information about the incoming traffic. For example, information about the cause of request may indicate that the paging is for incoming data, an incoming call or an incoming SMS. Information about the incoming traffic may indicate characteristics of the traffic if known by the UPF 404. For example, the UPF 404 may indicate delay sensitivity (e.g., a XR flow), periodicity, and/or throughput of an incoming traffic or 5-tuple information for downlink traffic. The TRF 408 may consider the cause of the request and incoming traffic information when determining an appropriate reachability strategy.

The TRF 408 may dynamically determine a WTRU reachability strategy (418) if the request is authorized. The determination of a WTRU reachability strategy may be based on information provided in the request (e.g., WTRU identifier, cause, and/or traffic characteristics), may be based on WTRU tracking information available in the network (e.g., available at the TRF 408 or obtained from another NF), and/or may be based on RCap, UECI, RInfo, and/or RConf. The TRF 408 may request predictions from the NWDAF 410 and/or from an AIML enablement layer (e.g., AIML enablement server and/or ADAES) about predicted WTRU reachability strategy to support the determination of a WTRU reachability strategy for the incoming traffic. The WTRU reachability strategy determined by the TRF 408 in 418 may include one or more AF 412.

The TRF 408 may send a WTRU reachability notification 420 to one or more AF 412. The TRF 408 may send a WTRU reachability notification 420 to one or more AF 412 according to the determined reachability strategy. The WTRU reachability notification 412 may include information about the WTRU identifier, incoming traffic and network connectivity that is requested by the network (e.g., requested data-plane resources re-activation, PDU session identifier, 5-tuple information of the downlink traffic, etc.). Upon receiving the WTRU reachability notification 420, the AF 412 may proceed to paging (424) and may send a notification response to the TRF 408 to indicate if the notification is authorized.

The TRF 408 may send a WTRU reachability response 422 to the UPF 404. The WTRU reachability response 422 may indicate whether the WTRU reachability request 416 was authorized by the TRF 408. The WTRU reachability response 422 may include information about the determined reachability strategy, the identity of determined WTRU reachability sources, and/or a prediction about the expected time to re-establish connectivity. For example, the expected time to re-establish connectivity may be used by the UPF 404 to estimate buffering needs for the incoming traffic.

Upon receiving the WTRU reachability notification 420, the AF 412 may send a paging request 424 to the application client on the WTRU 402 to indicate that the WTRU 402 should re-establish connectivity with the wireless network. A WTRU in idle mode (e.g., without NAS or RRC connectivity with the mobile network) may be connected to the AF 412 via an alternate network, such as a Wi-Fi, NTN, wired or tethered network that is not integrated with the wireless network, and may have connectivity with the AF.

The paging request message 424 may include the identifier of the paged WTRU, may include information about the connectivity that needs to be re-established (e.g., RAN connectivity, requested data-plane resources re-activation, PDU session identifier, 5-tuple information of the downlink traffic, etc.), and may include information about the cause of the paging cause and characteristics of the incoming traffic. The paging request message 424 may include the IP Address of the WTRU that the network wants to send data to. The WTRU 402 may use the 5-tuple information to determine what PDU session needs to be activated.

For example, if the TRF 408 determines that the WTRU 402 can be paged via an AF 412, the TRF 408 may send a WTRU reachability notification 420 to the AF 412, either directly or indirectly via an NEF. The WTRU reachability notification 420 may result in the AF 412 sending a paging request message 424 to the WTRU 410. It can be appreciated that the paging information may be encapsulated in an IP packet that may be sent by the AF 412 unidirectionally to the IP address of the paged WTRU 402. Upon receiving the paging request message 424, the WTRU 402 may verify if the paging request applies to the WTRU 402 and may indicate via an AT command that a paging indication has been received and that a service request (426) should be sent to the wireless network. The information provided in the WTRU reachability notification 420 (e.g., incoming traffic information and data-plane resources re-activation information, PDU session identifier, 5-tuple information for the downlink traffic) may be included in the paging request message 424 and may be provided via the AT command for triggering the service request.

The WTRU 402 may send a service request (426) to the wireless network (e.g., AMF 406), and the service request (426) may result in re-activation of data plane resources for one or more PDU sessions. It can be appreciated that information included in the paging request may influence which data plane resources are re-activated.

The TRF 408 may be notified of re-activation of one or more PDU sessions (428). The TRF 408 may have registered with the AMF and/or SMF 406 to be notified of such event. The TRF 408 may use WTRU re-activation information (e.g., WTRU identity, data-plane resource re-activated, AF information) to locally update reachability information and/or to update reachability information with the UDM/UDR. Additionally, the TRF 408 may send a WTRU reachability strategy result notification 430 to the NWDAF 410 to indicate the WTRU reachability strategy result. The WTRU reachability strategy result notification 430 may include timing information from the initial paging request until the PDU session re-activation, the result of the paging request, the selected paging strategy, and the tracking predictions used for selecting the paging strategy. The NWDAF 410 may use the provided information to train WTRU tracking and/or WTRU reachability models to further improve future predictions. It should be appreciated that the TRF 408 may additionally notify the AF about the reactivation of data plane resources to indicate the outcome of the WTRU reachability notification 420.

Upon detection of re-activation of data-plane resources (426), the UPF 404 may release the buffered traffic to the WTRU 402.

FIG. 5 is a signal diagram showing example reachability procedures between a WTRU 502 and a TRF 520 via alternative reachability sources. It should be understood that the reachability procedures shown in, and described with respect to, FIG. 5, may occur after reachability provisioning, as shown in, and described with respect to, FIG. 3. For example, as shown in, and described above with respect to, FIG. 2, RCap, UECI, RInfo, and/or RConf may be used to determine a WTRU reachability strategy, which may include reachability via different reachability sources or domains, such as a radio access network (RAN) (e.g., legacy paging), via one or more interworking gateway, via an AF, via PIN (e.g., PEGC/PEMC), via an aIoT trigger, or via a Prose relay.

In the example illustrated in FIG. 5, a UPF 516 may receive and buffer DL traffic. This may be performed similarly to, or the same as, the UPF 404 of FIG. 4 receives and buffers DL traffic in 414. The UPF may also send a WTRU reachability request 526 to a TRF 520. This may be performed similarly to, or the same as, the reachability request 416 sent by the UPF 404 of FIG. 4. The TRF 520 may determine a WTRU reachability strategy for the WTRU 502 (528). This may performed similarly to, or the same as, the TRF 408 determines the WTRU reachability strategy (418) for the WTRU 402 of FIG. 4. The WTRU reachability strategy (or RInfo) determined by the TRF 520 in 528 may include paging the WTRU 502 via one or more alternative reachability sources (e.g., RAN, interworking gateway(s), AF, PIN, aIoT, and/or Prose).

The TRF 520 may trigger a paging request with one or more alternative reachability sources. The TRF 520 may send a WTRU reachability notification to one or more alternative reachability sources according to reachability strategy determined in 528. The WTRU reachability notification may include information about an identity/identifier of the WTRU 502, information about incoming traffic and network connectivity requested by the network (e.g., requested data-plane resources re-activation, PDU session identifier, 5-tuple information of the downlink traffic, etc.). Based on the reachability strategy determined for the WTRU 502 in 528, the TRF 520 may determine to trigger one or more of the alternative reachability sources either concurrently or alternatively.

Relative to the example illustrated in FIG. 5, the TRF 520 may determine that the WTRU 502 should be paged via the RAN 504 and may send a WTRU reachability notification 530 to the RAN 504 indicating that the WTRU 502 may be paged using legacy paging mechanisms. The WTRU reachability notification 530 may result in the RAN 504 sending a paging request 532 over the paging channel. It should be appreciated that the information included in the WTRU reachability notification 530 may be used by the RAN 504 to dynamically determine one or more gNB for sending the paging indication request 532 on the paging channel of one or more gNBs.

The TRF 520 may also determine that the WTRU 502 should be paged via an interworking gateway 506 and may send a WTRU reachability notification 534 to one or more interworking gateway 506. The WTRU reachability notification 534 may result in the interworking gateway(s) 506 sending a paging request 536 to the WTRU 502 identified in the WTRU reachability notification 534. It should be appreciated that paging request information may be a NAS message encapsulated in an IP packet that may be sent unidirectionally to the IP address of a paged WTRU or broadcasted over the interworking network. Upon receiving the paging request 536, the WTRU 502 may verify whether the paging request 536 applies to the WTRU 502 and may indicate, via an AT command, that a paging request has been received and that a service request should be sent to the mobile network. The information provided in the WTRU reachability notification 534 may be included in the paging request 536 and may be provided via an AT command for triggering a service request 556.

The TRF 520 may also determine that the WTRU 502 should be paged via an AF 508 and may send a WTRU reachability notification 538 to the AF 508, either directly or indirectly via an NEF, similarly to WTRU reachability notification 420 sent by the TRF 408 to the AF 412 in FIG. 4. The AF 412 may send a paging request message 540 to the paged WTRU 502, and the paged WTRU 502 may trigger a service request via an AT command, as described above with respect to the paging request 424 sent by the AF 412 to the WTRU 402 in FIG. 4.

The TRF 520 may also determine that the WTRU 502 should be paged via a PIN 510 and may send a WTRU reachability notification 542 to the PEGC or PEMC 510. It should be appreciated that, in at least some embodiments, the WTRU reachability notification 542 may be sent to the PIN Server (e.g., as an AF) of the PIN and that the PIN server may relay the message to the PEGC or PEMC 510. The WTRU reachability notification 542 may result in the PEGC or PEMC 510 sending a paging request message 544 to the paged WTRU 502. It should be appreciated that the paging request information may be encapsulated in an IP packet that may be sent by the PEGC or PEMC 510 unidirectionally to the IP address of the paged WTRU 502 and that the message may be received by a PIN client present on the paged WTRU 502. Upon receiving the paging request message 544, the WTRU 502 may verify whether the paging request message 544 applies to the WTRU 502 and may indicate, via an AT command, that a paging request has been received and that a service request should be sent to the mobile network. The information provided in the WTRU reachability notification 542 (e.g., incoming traffic information and data-plane resources re-activation information) may be included in the paging request message 544 and may be provided via the AT command for triggering the service request 556.

The TRF 520 may also determine that the WTRU 520 should be paged via aIoT and may send a WTRU reachability notification 546 to an aIoT AN 512. The WTRU reachability notification 546 may result in the aIoT AN 512 sending a paging request 548 to the aIoT device 512 associated with the paged WTRU 502. It should be appreciated that the information included in the WTRU reachability notification 546 may be used by the aIoT AN 512 to dynamically determine an aIoT device triggering strategy. The aIoT device triggering strategy may result in triggering one or more aIoT device with a paging request 548 or sending the paging request 548 to an intermediate aIoT device for triggering an associated aIoT device. Upon receiving the paging request, the aIoT device (e.g., paged WTRU 502) may verify whether the paging request applies to the WTRU 502 and may indicate, via an AT command, that a paging request has been received and that a service request should be sent to the mobile network. The information provided in the WTRU reachability notification 546 (e.g., incoming traffic information and data-plane resources re-activation information) may be included in the paging request message 548 and may be provided, via the AT command, for triggering the service request 556.

The TRF 520 may also determine that the WTRU 520 should be paged via a Prose relay 514 and may send a WTRU reachability notification 550 to a Prose Relay 514. The WTRU reachability notification 550 may result in the Prose Relay 514 relaying the paging request message 552 to the paged WTRU 502. Upon receiving the paging request message 552, the WTRU 502 may verify whether the paging request message 552 applies to the WTRU 502 and may indicate, via an AT command, that a paging request has been received and that a service request should be sent to the mobile network. The information provided in the WTRU reachability notification 550 (e.g., incoming traffic information and data-plane resources re-activation information) may be included in the paging request 552 and may be provided via the AT command for triggering the service request 556.

Similar to the example illustrated in FIG. 4, in the example illustrated in FIG. 5, the TRF 520 may send a WTRU reachability response message 554 to the UPF 516. This may be performed similarly to the reachability response message 422 illustrated in FIG. 4 and described above.

Similar to the example illustrated in FIG. 4, in the example illustrated in FIG. 5, the WTRU 502 may send a service request message 556 to the AMF 518 resulting in data plane resources for the PDU session being re-activated. This may be performed similarly to the service request message 426 illustrated in FIG. 4 and described above.

Similar to the example illustrated in FIG. 4, in the example illustrated in FIG. 5, the AMF 518 may send a PDU session notification 560 to the TRF 520, which may cause the TRF 520 to send a WTRU reachability strategy results notification 562 to the NWDAF 522. This may be performed similarly to the PDU session notification 428 and the WTRU reachability strategy results notification 430 illustrated in FIG. 4 and described above.

Similar to the example illustrated in FIG. 4, in the example illustrated in FIG. 5, the UPF 516 may release the buffered DL traffic 558 to the WTRU 502. This may be performed similarly to the release of the buffered DL traffic 432 as illustrated in FIG. 4 and described above.

FIG. 6 is a flow diagram of an example method 600 of provisioning WTRU reachability, which may be implemented in a WTRU. In the example illustrated in FIG. 6, a WTRU may send a first message (602), which may a request message, or, more specifically, a request for WTRU reachability provisioning. The first message 602 may be the same as, or similar to, the WTRU reachability provisioning request 336 of FIG. 3 or the WTRU reachability provisioning request 322 of FIG. 3 (sent by the AMF 310 to the TRF 312 as a result of WTRU registration). More specifically, the first message 602 may include information indicating that the WTRU will not monitor a paging channel of the wireless network when the WTRU in an idle state.

The WTRU may receive a second message (604), which may be a response message, or, more specifically, a WTRU reachability provisioning response message. The second message 604 may be the same as, or similar to, the WTRU reachability provisioning response message 346 of FIG. 3 or the WTRU reachability provisioning response message 332 of FIG. 3 (sent by the TRF 312 via the AMF 310). More specifically, the second message may include information indicating a reachability strategy for the WTRU. The reachability strategy may be or include paging the WTRU via an alternate source when the WTRU is in the idle state.

The WTRU may locally configured itself to receive paging messages via at least one alternate source according to the reachability strategy indicated in 604. For example, the first message may include information indicating an alternate source for paging the WTRU when the WTRU is in the idle state as well as configuration information for paging the WTRU via the alternate source. In some embodiments, the WTRU may configured itself by establishing connectivity with at least one of a server, a device or a network corresponding to the alternate source and/or listening on a port for paging notifications from the alternate source.

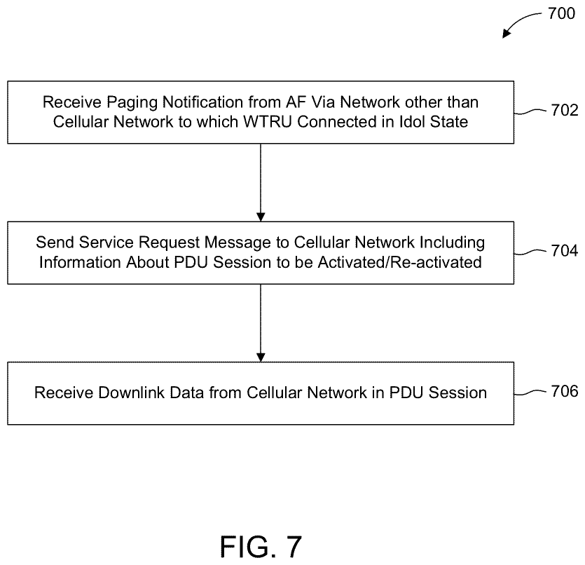

FIG. 7 is a flow diagram of an example method 700 of paging a WTRU in an idle state when a reachability strategy has been provisioned for the WTRU, which may be implemented in a WTRU. In the example illustrated in FIG. 7, a WTRU that is connected to a wireless network in an active state may enter an idle state and disconnect from the network. The WTRU may then receive a third message (702) via an alternate source indicated in the reachability strategy. The third message 702 may be paging notification received from an AF, or other alternate paging source, as described above with respect to the paging request message 424 of FIG. 4 and/or any of the paging request messages 532, 536, 540, 544 and/or 548 of FIG. 5.

The WTRU may send a fourth message (704) to the wireless network. The fourth message may be a service request message and may include information indicating at least one PDU session to be activated or re-activated. The fourth message 704 may be, for example, the same as, or similar to, the service request message 426 of FIG. 4. The WTRU may then receive downlink data from the wireless network in the activated/re-activated PDU session (706). In some embodiments, data buffered at the UPF may be released to the WTRU similar to 432 in FIG. 4 and/or 556 in FIG. 5.

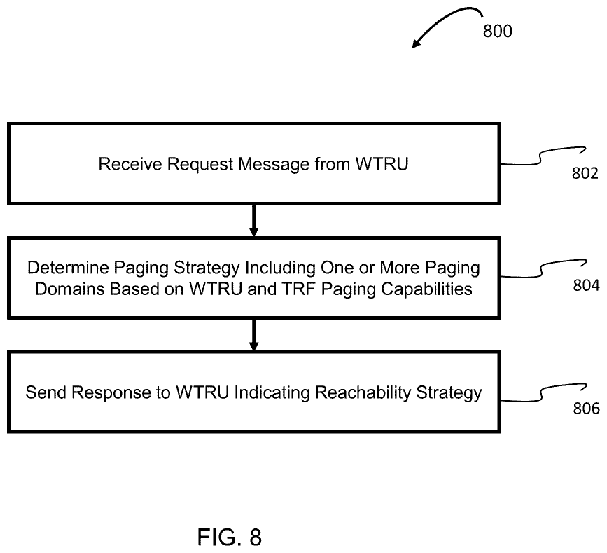

FIG. 8 is a flow diagram of an example method 800 of provisioning WTRU reachability, which may be implemented at the TRF 216 in the core network 212, as shown in FIG. 2. In the example illustrated in FIG. 8, the TRF may receive a first message from a WTRU (802), which may a request message, or, more specifically, a request for WTRU reachability provisioning. The first message 802 may be the same as, or similar to, the WTRU reachability provisioning request 336 of FIG. 3 or the WTRU reachability provisioning request 322 of FIG. 3 (sent by the AMF 310 to the TRF 312 as a result of WTRU registration). More specifically, the first message 802 may include information indicating that the WTRU will not monitor a paging channel of the wireless network when the WTRU is in an idle state.

The TRF may determine a reachability strategy for the WTRU (804). The TRF may determine the reachability strategy similar to, or the same way as, the TRF 408 determines the reachability strategy in 422 (FIG. 4) and/or the TRF 520 determines the reachability strategy in 528 (FIG. 5). The reachability strategy may be or include paging the WTRU via an alternate source when the WTRU is in the idle state and/or may be or include an order in which one or more different reachability domains should be attempted for paging the WTRU in an idle state. In some embodiments, the TRF may determine that data analytics services are to be used to assist in determining the reachability strategy. The TRF may, accordingly, obtain data analytics services provided by at least one of a network data and analytics function (NWDAF) of the cellular network, an application data analytics and enablement service (ADAES), or an artificial intelligence/machine learning enablement (AI/MLE) layer.

The TRF may receive a second message (806), which may be a response message, or, more specifically, a WTRU reachability provisioning response message. The second message 806 may be the same as, or similar to, the WTRU reachability provisioning response message 346 of FIG. 3 or the WTRU reachability provisioning response message 332 of FIG. 3 (sent by the TRF 312 via the AMF 310). More specifically, the second message may include information indicating a reachability strategy for the WTRU.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A wireless transmit/receive unit (WTRU) comprising:
a transceiver; and
a processor,
wherein the transceiver and the processor are configured to connect to a wireless network,
wherein the transceiver and the processor are further configured to send a first message, via the wireless network, wherein the first message comprises information indicating that the WTRU will not monitor a paging channel of the wireless network when the WTRU is in an idle state, and
wherein the transceiver and the processor are further configured to receive a second message, via the wireless network, wherein the second message comprises information indicating a reachability strategy for the WTRU, wherein the reachability strategy comprises paging the WTRU via an alternate source when the WTRU is in the idle state.

2. The WTRU of claim 1, wherein:
the transceiver and the processor are further configured to disconnect the WTRU from the wireless network in the idle state,
the transceiver and the processor are further configured to receive a third message, when the WTRU is in the idle state, via the alternate source, and
the transceiver and the processor are further configured to re-establish connectivity of the WTRU with the wireless network based on information included in the third message.

3. The WTRU of claim 2, wherein:
the third message comprises a paging notification that includes information indicating that the wireless network has downlink data for the WTRU,
the transceiver and the processor are further configured to send a fourth message, to the wireless network, in response to the third message, wherein the fourth message comprises information indicating at least one protocol data unit (PDU) session to be activated or re-activated, and
the transceiver and the processor are further configured to receive the downlink data from the wireless network in the at least one PDU session.

4. The WTRU of claim 1, wherein:
the first message further comprises information indicating the alternate source for paging the WTRU when the WTRU is in the idle state, and configuration information for paging the WTRU via the alternate source, and
wherein the transceiver and the processor are further configured to locally configure the WTRU to receive paging notifications via the alternate source when the WTRU is in the idle state.

5. The WTRU of claim 4, wherein the transceiver and the processor are further configured to locally configure the WTRU by at least one of:
establishing connectivity with at least one of a server, a device or a network corresponding to the alternate source, or
listening on a port for paging notifications from the alternate source.

6. The WTRU of claim 1, wherein the alternate source comprises at least one of a WiFi network, a radio access network (RAN), a personal Internet-of-Things network (PIN), an interworking gateway, ambient IoT (aIoT), an application function (AF), or a proximity services (Prose) relay.

7. The WTRU of claim 1, wherein the alternate source comprises a plurality of alternate sources, and the reachability strategy indicates an order in which the WTRU should attempt to use the plurality of alternate sources to receive paging notifications when the WTRU is in the idle state.

8. The WTRU of claim 1, wherein the first message further comprises information indicating capabilities of the WTRU for reaching other WTRUs for paging, wherein the information includes at least one of:
information indicating that the WTRU is capable of acting as a mobile hotspot to send paging notifications to connected WTRUs, or
information indicating that the WTRU is capable of acting as a proximity services (Prose) relay to send paging indications to the connected WTRUs.

9. The WTRU of claim 1, wherein the first message further comprises at least one of:
information indicating a preferred one of the plurality of alternate sources for paging the WTRU when the WTRU is in the idle state,
information indicating a preferred location for the WTRU to receive paging notifications when the WTRU is in the idle state, or
information indicating at least one preferred IP port for the WTRU to receive paging notifications when the WTRU is in the idle state.

10. A network node in a wireless network, the network node comprising:
a transceiver, and
a processor,
wherein the transceiver and the processor are configured to receive a first message, from a wireless transmit/receive unit (WTRU) connected to the wireless network, wherein the first message comprises information indicating that the WTRU will not monitor a paging channel of the wireless network when the WTRU is in an idle state, and
wherein the transceiver and the processor are further configured to send a second message, to the WTRU, wherein the second message comprises information indicating a reachability strategy for the WTRU, wherein the reachability strategy comprises paging the WTRU via an alternate source when the WTRU is in the idle state.

11. The network node of claim 10, wherein the first message further comprises information indicating the alternate source for paging the WTRU when the WTRU is in the idle state, and configuration information for paging the WTRU via the alternate source.

12. The network node of claim 11, wherein the alternate source comprises a plurality of alternate sources, and the reachability strategy indicates an order in which the WTRU should attempt to use the plurality of alternate sources to receive paging notifications when the WTRU is in the idle state.

13. The network node of 10, wherein the processor and the transceiver are further configured to determine the reachability strategy by:
determining that data analytics services are to be used to assist in determining the reachability strategy, and
obtaining data analytics services provided by at least one of:
a network data and analytics function (NWDAF) of the cellular network,
an application data analytics and enablement service (ADAES), or
an artificial intelligence/machine learning enablement (AI/MLE) layer.

14. The network node of claim 10, wherein the alternate source comprises at least one of a WiFi network, a radio access network (RAN), a personal Internet-of-Things network (PIN), an interworking gateway, ambient IoT (aIoT), an application function (AF), or a proximity services (Prose) relay.

15. A method, implemented in a wireless transmit/receive unit (WTRU), the method comprising:
connecting to a wireless network;
sending a first message, via the wireless network, wherein the first message comprises information indicating that the WTRU will not monitor a paging channel of the wireless network when the WTRU is in an idle state; and
receiving a second message, via the wireless network, wherein the second message comprises information indicating a reachability strategy for the WTRU, wherein the reachability strategy comprises paging the WTRU via an alternate source when the WTRU is in the idle state.

16. The method of claim 15, further comprising:
disconnecting the WTRU from the wireless network in the idle state;
receiving a third message, when the WTRU is in the idle state, via the alternate source; and
re-establishing connectivity of the WTRU with the wireless network based on information included in the third message.

17. The method of claim 15, wherein the third message comprises a paging notification that includes information indicating that the wireless network has downlink data for the WTRU, and the method further comprises:
sending a fourth message, to the wireless network, in response to the third message, wherein the fourth message comprises information indicating at least one protocol data unit (PDU) session to be activated or re-activated; and
receiving the downlink data from the wireless network in the at least one PDU session.

18. The method of claim 15, wherein the first message further comprises information indicating the alternate source for paging the WTRU when the WTRU is in the idle state, and configuration information for paging the WTRU via the alternate source, and wherein the method further comprises:
locally configuring the WTRU to receive paging notifications via the alternate source when the WTRU is in the idle state.

19. The method of claim 15, wherein the locally configuring the WTRU further comprises at least one of:
establishing connectivity with at least one of a server, a device or a network corresponding to the alternate source, or
listening on a port for paging notifications from the alternate source.

20. The method of claim 15, wherein the alternate source comprises at least one of a WiFi network, a radio access network (RAN), a personal Internet-of-Things network (PIN), an interworking gateway, ambient IoT (aIoT), an application function (AF), or a proximity services (Prose) relay.
